(19) United States
(12) Patent Application Publication
(10) Pub. No.: US 2020/0204512 A1
(43) Pub. Date: Jun. 25, 2020

(54) ELECTRONIC APPARATUS, NON-TRANSITORY COMPUTER-READABLE RECORDING MEDIUM STORING STATE MANAGEMENT PROGRAM IN ELECTRONIC APPARATUS, AND STATE MANAGEMENT METHOD IN ELECTRONIC APPARATUS

(71) Applicant: SHARP KABUSHIKI KAISHA, Sakai City (JP)

(72) Inventor: KAZUHIKO IDO, Sakai City (JP)

(21) Appl. No.: 16/726,688

(22) Filed: Dec. 24, 2019

(30) Foreign Application Priority Data
Dec. 25, 2018 (JP) 2018-240499

(51) Int. Cl. H04L 12/58; H04W 4/12; H04M 3/537

(52) U.S. Cl. CPC H04L 51/24; H04W 4/12; H04M 2242/30; H04M 3/537; H04L 51/34

(57) ABSTRACT

According to a multifunction machine as an electronic apparatus according to the present invention, a badge is arranged on a screen displayed on a display. A number indicating an undelivery number is assigned to the badge. The multifunction machine includes a human sensor that senses the presence or absence of a user in a predetermined area at the periphery of the multifunction machine. Based on a sensing result by the human sensor, determination on whether or not a message is delivered to the user is made. Then, based on such a determination result, the undelivery number is managed.

### BACKGROUND OF THE INVENTION

### Field of the Invention

The present invention relates to an electronic apparatus, a non-transitory computer-readable recording medium storing a state management program in the electronic apparatus, and a state management method in the electronic apparatus. Particularly, the present invention relates to an electronic apparatus that outputs, when an event that needs to be notified to a user occurs, a message corresponding to the event via voice and a state management program and a state management method in the electronic apparatus.

### Description of the Background Art

One example of the technique of this type is disclosed in Japanese Unexamined Patent Application Publication No. 2000-69519. According to the technique disclosed in Japanese Unexamined Patent Application Publication No. 2000-69519, in a case where calling and reporting for reporting reception of a message via sound is automatically stopped due to timeout in a wireless selective calling apparatus as an electronic apparatus, such a message is taken as an unread message. On the other hand, in a case where calling and reporting are manually stopped before timeout, such a message is taken as a read message. Then, a number of unread messages is counted for each message type, and the number of unread messages counted is displayed on a display.

In the technique disclosed in Japanese Unexamined Patent Application Publication No. 2000-69519 described above, in a case where calling and reporting are, for example, not manually stopped by a user although the message is delivered to the user, such a message is taken as the unread message. That is, the message that needs to be taken as the read message might be erroneously taken as the unread message. In this case, the number of unread messages displayed on the display is also an erroneous value.

For this reason, an object of the present invention is to provide a new electronic apparatus that can accurately manage an undelivery number as a number of messages not delivered to a user, a non-transitory computer-readable recording medium storing a state management program in the electronic apparatus, and a state management method in the electronic apparatus.

### SUMMARY OF THE INVENTION

For accomplishing the object, the present invention includes a first aspect of the invention according to the electronic apparatus, a second aspect of the invention according to the state management program in the electronic apparatus, and a third aspect of the invention according to the state management method in the electronic apparatus.

The first aspect of the invention according to the electronic apparatus includes a notification device, an estimation device, a determination device, and a management device. The notification device outputs, when an event that needs to be notified to a user occurs, a message corresponding to the event via voice. The estimation device estimates action of the user including presence or absence of the user in a predetermined area at the periphery of the electronic apparatus. The determination device determines, based on an estimation result by the estimation device, whether or not the message is delivered to the user. Moreover, the management device manages, based on a determination result by the determination device, an undelivery number as a number of messages not delivered to the user.

Note that the first aspect of the invention may further include a display device and a display control device. The display device described herein has a display surface. Moreover, the display control device displays a management result by the management device on the display surface of the display device.

In the configuration including the display device and the display control device, the display control device may display a predetermined screen on the display surface of the display device, and may display the management result as additional information on the screen.

Moreover, the first aspect of the invention may further include an operation receiving device. The operation receiving device can receive operation by the user. In this case, the determination device may perform determination based on the estimation result by the estimation device and an operation result by the operation receiving device.

Further, when any event according to the undelivery number is solved, the management device preferably subtracts a number corresponding to a number of solved events from the undelivery number.

In addition, the first aspect of the invention may further include a re-notification device. The re-notification device outputs the message corresponding to each event according to the undelivery number via voice when a predetermined condition is satisfied.

In the configuration including the re-notification device, when re-notification as the output of the message by the re-notification device is performed, the management device preferably substrates a number corresponding to a number of times of execution of re-notification from the undelivery number.

In addition, in the configuration including the re-notification device, a priority may be set in advance for each event. Moreover, in a case where the undelivery number is two or more, the re-notification device may output, every time the above-described predetermined condition is satisfied, a message corresponding to a highest-priority event with the highest priority among two or more events according to the undelivery number.

The estimation device in the first aspect of the invention may include at least one of a human sensing device or an image capturing device. The human sensing device described herein senses the presence or absence of persons including the user in the above-described predetermined area. The image capturing device captures an image in the predetermined area, and specifically captures video.

The electronic apparatus according to the first aspect of the invention is, for example, a multifunction machine (multifunction peripheral: MFP).

The non-transitory computer-readable recording medium storing the state management program in the electronic apparatus according to the second aspect of the invention causes a computer of the electronic apparatus to implement a notification procedure, an estimation procedure, a determination procedure, and a management procedure. Specifically, in the notification procedure, when an event that needs to be notified to a user occurs, a message corresponding to the event is output via voice. In the estimation procedure, action of the user including the presence or absence of the user in a predetermined area at the periphery of the electronic apparatus is estimated. In the determination procedure, it is, based on an estimation result by the estimation procedure, determined whether or not the message is delivered to the user. Moreover, in the management procedure, an undelivery number as the number of messages not delivered to the user is managed based on a determination result by the determination procedure.

The state management method in the electronic apparatus according to the third aspect of the invention includes notifying, estimating, determining, and managing. Specifically, in the notifying, when an event that needs to be notified to a user occurs, a message corresponding to the event is output via voice. In the estimating, action of the user including the presence or absence of the user in a predetermined area at the periphery of the electronic apparatus is estimated. In the determining, it is, based on an estimation result by the estimation step, determined whether or not the message is delivered to the user. Moreover, in the managing, an undelivery number as the number of messages not delivered to the user is managed based on a determination result by the determination step.

According to the present invention having the above-described configuration, the undelivery number as the number of messages not delivered to the user can be accurately managed. This is extremely useful in, for example, providing an accurate undelivery number to the user and efficiently and reliably delivering the message corresponding to each event according to the undelivery number to the user.

### BRIEF DESCRIPTION OF THE DRAWINGS

FIG. 1 is a perspective view of an outer appearance of a multifunction machine according to a first embodiment of the present invention;

FIG. 2 is a view of a sensing area of a human sensor of the first embodiment from above;

FIG. 3 is a block diagram of an electric configuration of the multifunction machine according to the first embodiment;

FIG. 4 is a view of one example of a display screen of a display in the first embodiment;

FIG. 5 is a view of one example of the display screen of the display and a speaker state upon notification regarding a certain event in the first embodiment;

FIG. 6 is a view of a list of events in the first embodiment;

FIG. 7 is a conceptual diagram of a configuration of a message table in the first embodiment;

FIG. 8 is a view of one example of the display screen of the display after notification regarding the certain event in the first embodiment;

FIG. 9 is a view of one example of the display screen of the display and the speaker state upon notification regarding a different event in the first embodiment;

FIG. 10 is a view of one example of the display screen of the display after notification regarding the different event in the first embodiment;

FIG. 11 is a view of one example of the display screen of the display and the speaker state upon re-notification regarding the certain event in the first embodiment;

FIG. 12 is a conceptual diagram of a configuration of an event management table in the first embodiment;

FIG. 13 is a conceptual diagram of a configuration of an undelivery management table in the first embodiment;

FIG. 14 is a memory map conceptually illustrating a configuration in a random access memory (RAM) of a main storage in the first embodiment;

FIG. 15 is a flowchart of the flow of a state management task in the first embodiment;

FIG. 16 is a flowchart of part of the flow of a notification management task in the first embodiment;

FIG. 17 is a flowchart of the remaining part of the flow of the notification management task in the first embodiment;

FIG. 18 is a flowchart of the flow of an undelivery number management task in the first embodiment;

FIG. 19 is a flowchart of part of the flow of a re-notification task in the first embodiment;

FIG. 20 is a flowchart of the remaining part of the flow of the re-notification task in the first embodiment;

FIG. 21 is a view of one example of a display screen of a display and a speaker state upon notification regarding a certain event in a second embodiment of the present invention;

FIG. 22 is a view of one example of the display screen of the display and the speaker state upon notification regarding a different event in the second embodiment; and

FIG. 23 is a view of a configuration including a multifunction machine according to a third embodiment of the present invention.

### DESCRIPTION OF THE PREFERRED EMBODIMENTS

### First Embodiment

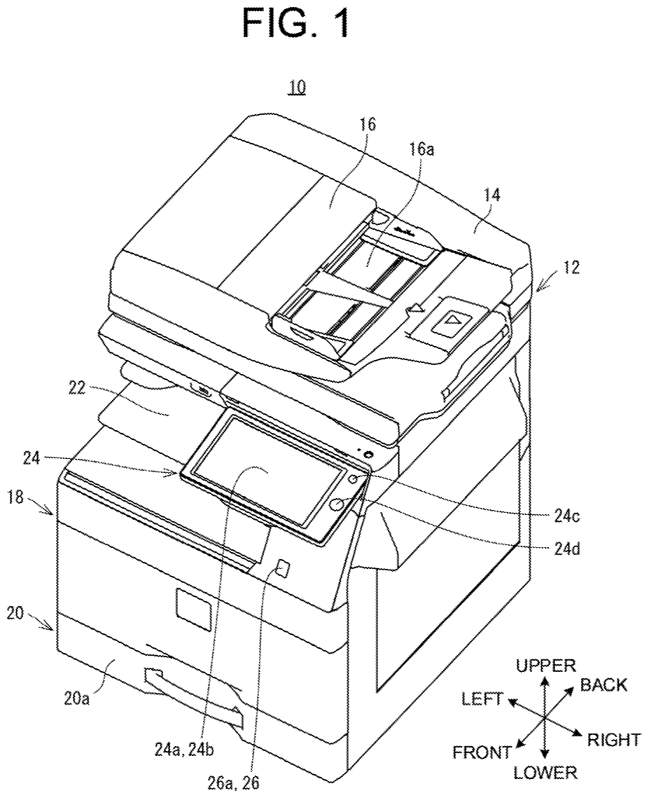

Regarding a first embodiment of the present invention, a multifunction machine 10 illustrated in FIG. 1 will be described by way of example.

The multifunction machine 10 according to the first embodiment includes a plurality of functions such as a copy function, a printer function, an image scanner function, and a facsimile function. Note that FIG. 1 is a perspective view of an outer appearance of the multifunction machine 10 illustrating a front surface, an upper surface, and a right surface of the multifunction machine 10 placed in a usable state. That is, an upper-to-lower direction in FIG. 1 corresponds to an upper-to-lower direction of the multifunction machine 10. Moreover, a lower left in FIG. 1 corresponds to the front of the multifunction machine 10, and an upper right in FIG. 1 corresponds to the back of the multifunction machine 10. In addition, an upper left in FIG. 1 corresponds to the left of the multifunction machine 10, and a lower right in FIG. 1 corresponds to the right of the multifunction machine 10.

At an upper portion of (a housing of) the multifunction machine 10, an image reader 12 as one example of an image reading device is provided. The image reader 12 plays a role in the image reading processing of reading an image of a not-illustrated document to output two-dimensional image data corresponding to the document image. Thus, the image reader 12 has a not-illustrated platen on which the document is to be placed. The platen is formed by a transparent member such as flat plate-shaped glass. In addition, a document holding cover 14 for pressing the document placed on the platen is provided above the platen. The document holding cover 14 is openably attached through a not-illustrated hinge. Moreover, a not-illustrated light source, an optical member including proper mirror and lens, an image reading device having a line sensor etc., and a drive mechanism that moves the image reading device along a lower surface of the platen are provided below the platen, for example.

Further, an automatic document feeding device (Auto Document Feeder: ADF) 16 is provided at an upper portion of the document holding cover 14. The automatic document feeding device 16 has a document placement tray 16a in which a plurality of sheet-shaped documents can be placed in the stack. Moreover, the automatic document feeding device 16 supplies, one by one, the documents placed in the document placement tray 16a to an image reading position of the image reader 12. Note that the automatic document feeding device 16 is an optional device, and therefore, is not provided in some cases.

Moreover, an image former 18 as an image forming device is provided below the image reader 12. The image former 18 plays a role in the image forming processing of forming, by a well-known electrophotographic method, an image on a not-illustrated sheet-shaped image recording medium supplied one by one from a paper feeder 20, such as paper. The image forming processing can also accept any of black-and-white and colors. Thus, the image former 18 has, for each of the black-and-white (K) and the colors (CMY), a photosensitive drum, a charging device, an exposure device, a developing device, a transfer device, a fixing device, etc. not illustrated in the figure. Specifically, the developing device has not-illustrated toner cartridges. The paper after the image forming processing by the image former 18, i.e., printed paper, is discharged to a paper discharge tray 22. Note that the paper discharge tray 22 is formed by an inner body space between the image reader 12 and the image former 18, but may have other structures. Moreover, only one paper feeding cassette 20a forming the paper feeder 20 is provided in FIG. 1, but a plurality of paper feeding cassettes 20a may be provided.

In addition, a substantially rectangular plate-shaped operation device 24 is provided at a front portion of the multifunction machine 10, specifically a front portion of (a housing of) the image reader 12. The operation device 24 is provided such that one principal surface thereof is slightly inclined to the front side of the multifunction machine 10, i.e., one principal surface faces diagonally upward. A display 24b with a touch panel 24a is provided on an upper surface of the operation device 24 as one principal surface. In addition, a power saving button 24c and a home button 24d are provided on the upper surface of the operation device 24.

The display 24b with the touch panel 24a is a member formed in such a manner that the display 24b having a rectangular display surface and the sheet-shaped touch panel 24a provided to overlap with the display surface of the display 24b are integrally combined. Of these elements, the touch panel 24a is one example of an operation receiving device that can receive operation by a user using the multifunction machine 10, and for example, is a capacitance panel. Moreover, the display 24b is one example of a display device, and for example, is a liquid crystal display (LCD). Various types of information are displayed on the display surface of the display 24b, and a predetermined screen including a later-described home screen 100 is specifically displayed. Note that the touch panel 24a is not limited to the capacitance panel, and may be other types of panels such as panels of an electromagnetic induction type, a resistance film type, and an infrared type. Moreover, the display 24b is not limited to the liquid crystal display, and may be such as an organic electroluminescence (EL) display.

The power saving button 24c is provided at the right of the display 24b with the touch panel 24a. The power saving button 24c is also one example of the operation receiving device, and is specifically one example of the operation receiving device for causing an operation mode of the multifunction machine 10 to transition from a normal mode to a power saving mode or from the power saving mode to the normal mode. The power saving button 24c is, for example, a capacitance switch, but may be other hardware keys.

The normal mode described herein is a mode when the multifunction machine 10 is in a normal state. In the normal mode, the multifunction machine 10 is in a warm-up state, i.e., a state in which an external command including user operation for the touch panel 24a can be promptly responded. Moreover, the power saving mode is a mode when the multifunction machine 10 is in a power saving state. In the power saving mode, a power supply to some elements such as the image reader 12, the image former 18, and the display 24b with the touch panel 24a is stopped. In the power saving mode, when the power saving button 24c is operated (pressed), the operation mode of the multifunction machine 10 transitions from the power saving mode to the normal mode. That is, the power supply to the elements to which the power supply is stopped begins, i.e., warm-up begins. On the other hand, when the power saving button 24c is operated in the normal mode, the operation mode of the multifunction machine 10 transitions from the normal mode to the power saving mode.

As in the power saving button 24c, the home button 24d is provided at the right of the display 24b with the touch panel 24a, i.e., is provided in the vicinity of the power saving button 24c. The home button 24d is also one example of the operation receiving device, and is specifically one example of the operation receiving device for displaying the later-described home screen 100 on the display 24b. The home button 24d is, for example, a capacitance switch, but may be other hardware keys.

Note that the user usually stands in the front of the multifunction machine 10 to use the multifunction machine 10, specifically use the operation device 24. For providing favorably operability and visibility of the operation device 24 by the user at this point, the operation device 24 is, as described above, provided such that the upper surface thereof is slightly inclined to the front side of the multifunction machine 10. Moreover, the operation device 24 is provided rotatably about a portion joined to the image reader 12 as an axis so that an inclination angle of the upper surface of the operation device 24 can change within a proper range.

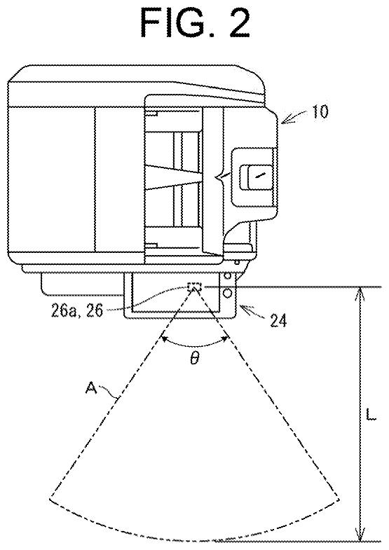

Further, a human sensor 26 is provided at a proper position of the multifunction machine 10, such as a position of the front portion of the multifunction machine 10 below the operation device 24. The human sensor 26 is one example of a human sensing device for sensing whether or not persons including the user are present at the periphery of the multifunction machine 10. Specifically, as illustrated in FIG. 2, the human sensor 26 forms a sensing area A as a predetermined area on the front side of the multifunction machine 10 as the user standing position. Moreover, the human sensor 26 senses the presence or absence of the person within the sensing area A, and precisely outputs a human sensing signal corresponding to the presence or absence of the person. The human sensor 26 has a human-presence sensor 26a. For example, a pyroelectric sensor as one type of an infrared sensor is employed as the human-presence sensor 26a.

Note that FIG. 2 is a view of the sensing area A from above, i.e., illustrates the sensing area A in the horizontal direction. According to FIG. 2, the sensing area A in the horizontal direction is in a well-formed fan shape, but is actually in a slightly-distorted shape. The directional angle (center angle) θ of the sensing area A in the horizontal direction is mainly determined by specifications and an attachment structure of the human-presence sensor 26a, but is changeable within a certain range by an electrical setting (for example, a drive power or an amplifier circuit gain) of the human sensor 26 including the human-presence sensor 26a. Although not illustrated in the figure, the same also applies to the sensing area A in the vertical direction. The distance (sensing distance) L of the sensing area A is also mainly determined by the specifications and the attachment structure of the human-presence sensor 26a, but is changeable within a certain range by the electrical setting of the human sensor 26 including the human-presence sensor 26a.

The human sensor 26 is, for example, used for shortening time required for the warm-up described above. Specifically, when the multifunction machine 10 is in the power saving mode, if the human sensor 26 senses the persons (precisely some kinds of objects) including the user, the operation mode of the multifunction machine 10 transitions from the power saving mode to the normal mode. That is, the warm-up begins only by approaching of the user to the multifunction machine 10 without the need for operating the power saving button 24c. This shortens the warm-up time. Note that although detailed description will be omitted, shortening of the warm-up time by means of the human sensor 26 can be properly activated or deactivated by a predetermined setting (a system setting).

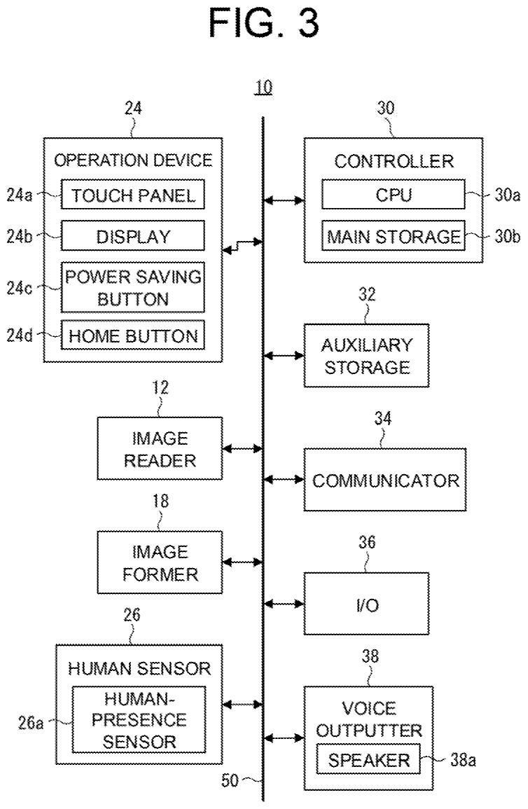

FIG. 3 is a block diagram of an electrical configuration of the multifunction machine 10. As illustrated in FIG. 3, the multifunction machine 10 includes, in addition to the above-described image reader 12, the above-described image former 18, the above-described operation device 24, and the above-described human sensor 26, a controller 30, an auxiliary storage 32, a communicator 34, an input/output interface (I/O) 36, and a voice outputter 38. These elements are connected to each other via a common bus 50. Note that the image reader 12, the image former 18, the operation device 24, and the human sensor 26 are as described above. Moreover, in FIG. 3, elements directly relating to the present invention are not illustrated in the figure.

The controller 30 is one example of a control device playing a role in overall control of the multifunction machine 10. Thus, the controller 30 has a central processing unit (CPU) 30a as a control execution device. In addition, the controller 30 has a main storage 30b as a main storage device directly accessible by the CPU 30a. Although not illustrated in the figure, the main storage 30b includes a read only memory (ROM) and a random access memory (RAM). Of these elements, the ROM stores a control program (firmware) for controlling operation of the CPU 30a. Moreover, the RAM forms a working area and a buffer area when the CPU 30a executes processing based on the control program. Further, the main storage 30b includes a not-illustrated rewritable non-volatile memory. The non-volatile memory stores data that might be rewritten, such as a later-described message table 300.

The auxiliary storage 32 is one example of an auxiliary storage device, and for example, includes a not-illustrated hard drive. Moreover, the auxiliary storage 32 includes, in some cases, a rewritable non-volatile memory different from that of the main storage 30b. The auxiliary storage 32 stores, as necessary, various types of data such as the image data output from the image reader 12 and subsequently-described data received via the communicator 34.

The communicator 34 is one example of a communication device connected to a network such as a not-illustrated local area network (LAN) to perform bidirectional communication processing via the network. A communication partner via the network may include, for example, a not-illustrated personal computer, a not-illustrated server, and a not-illustrated router. Moreover, the communicator 34 is also connected to a not-illustrated public phone line to perform bidirectional communication processing via the public phone line. A communication partner via the public phone line may include, for example, a not-illustrated facsimile apparatus.

The input/output interface 36 is one example of an interface device that mediates connection among various electrical elements including a not-illustrated paper delivery sensor, a not-illustrated paper feeding sensor, and a not-illustrated paper discharge sensor forming the multifunction machine 10 and the controller 30. Note that the paper delivery sensors are sensors provided at a plurality of spots in the middle of a not-illustrated paper delivery path in (the housing of) the multifunction machine 10 to sense (the position of) paper delivered in the paper delivery path. The paper delivery sensor also functions as a sensor for sensing paper stagnation, i.e., paper jam, in the paper delivery path. Moreover, the paper feeding sensor is a sensor for sensing the presence of absence of paper in the paper feeding cassette 20a. Moreover, the paper discharge sensor is a sensor for sensing a state in which the accumulation amount of printed paper discharged to the paper discharge tray 22 reaches a certain amount, i.e., a state in which the paper discharge tray 22 is full.

The voice outputter 38 is one example of a voice output device that outputs, via voice (synthetic voice), a guidance regarding an instruction manual for the multifunction machine 10, a later-described message, etc. Thus, the voice outputter 38 has a speaker 38a. Note that in FIG. 1, the speaker 38a is not illustrated, but for example, is provided at any of a front surface portion, a right surface portion, or a left surface portion of (the housing of) the multifunction machine 10.

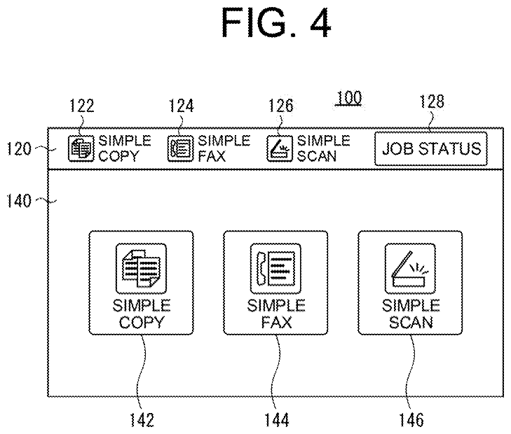

In the multifunction machine 10 having the above-described configuration, when the multifunction machine 10 is powered on, the home screen 100 as a basic screen as illustrated in FIG. 4 is displayed on the display 24b. The home screen 100 is one of operation screens for operating the multifunction machine 10, i.e., so-called user interface (UI) screens.

Specifically, the home screen 100 includes a band-shaped display area 120 and a main display area 140. Of these areas, the band-shaped display area 120 is a horizontally-elongated band-shaped area covering an upper portion of the home screen 100. In the band-shaped display area 120, a copy selection button 122 as an operator for selecting the copy function, a facsimile (FAX) selection button 124 for selecting the facsimile function, and a scan selection button 126 for selecting the image scanner function are arranged, for example. In addition, in the band-shaped display area 120, a job status checking button 128 for checking the job status of the multifunction machine 10 such as an in-execution status, a standby status, or an executed status is arranged. Note that these buttons 122, 124, 126, and 128 are arranged side by side, but arrangement of the buttons 122, 124, 126, and 128 is not limited to above. Note that for distinguishing the job status checking button 128 from other buttons 122, 124, and 126, the job status checking button 128 is preferably arranged at either one of right and left end portions of the band-shaped display area 120, for example.

The main display area 140 is other areas of the home screen 100 than the band-shaped display area 120, i.e., a rectangular area covering a large portion of the home screen 100. In the main display area 140, a copy selection button 142, a FAX selection button 144, and a scan selection button 146 larger than the copy selection button 122, the FAX selection button 124, and the scan selection button 126 in the band-shaped display area 120 are arranged side by side. Arrangement of these buttons 142, 144, and 146 in the main display area 140 is not limited to above, but is preferably similar to arrangement of the copy selection button 122, the FAX selection button 124, and the scan selection button 126 in the band-shaped display area 120.

Although detailed description including illustration will be omitted, when, for example, the copy selection button 122 in the band-shaped display area 120 or the copy selection button 142 in the main display area 140 is operated on the home screen 100, an operation screen for the copy function is displayed instead of the home screen 100. Using the operation screen for the copy function, operation for using the copy function is performed. Similarly, when the FAX selection button 124 in the band-shaped display area 120 or the FAX selection button 144 in the main display area 140 is operated, an operation screen for the facsimile function is displayed instead of the home screen 100. Moreover, when the scan selection button 126 in the band-shaped display area 120 or the scan selection button 146 in the main display area 140 is operated, an operation screen for the image scanner function is displayed instead of the home screen 100. On any operation screen, the job status checking button 128 is arranged similarly. When the job status checking button 128 is operated, a screen for checking the job status is displayed.

Note that in addition to the buttons 122, 124, 126, 128, 142, 144, and 146, various elements such as proper operators and character strings are arranged on the home screen 100, but elements not directly relating to the gist of the present invention are not illustrated in FIG. 4. Moreover, the design of the home screen 100 illustrated in FIG. 4 is one example, and is not limited to above.

In addition, the multifunction machine 10 according to the first embodiment includes a notification function for notifying, when an event that needs to be notified to the user occurs, the user of the event.

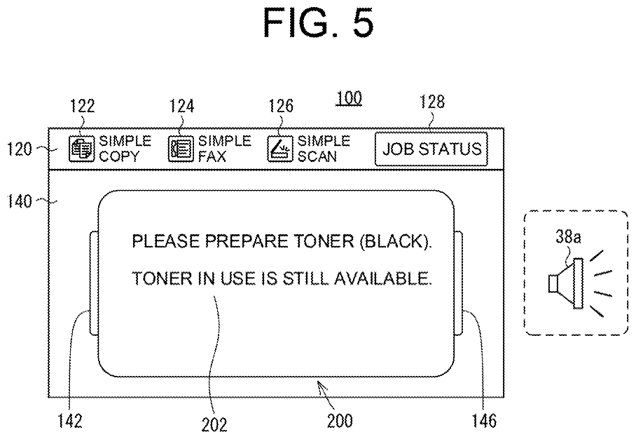

For example, when a decrease in a black toner remaining amount, i.e., a small toner remaining amount event, occurs, a dialogue box 200 as a message screen as illustrated in FIG. 5 is displayed on the display 24b, and is specifically displayed to cover at least part of the main display area 140. The dialogue box 200 includes a proper character string 202 indicating the contents of the occurred event, i.e., the event that the black toner remaining amount is small. In addition, voice indicating the contents of the occurred event, such as the same contents as those of the character string 202, is output from the speaker 38a of the voice outputter 38. That is, a message indicating the contents of the occurred event is output (notified) in a visual form as the dialogue box 200 including the character string 202 and an auditory form as the voice. Thus, the user receives such an output message so that the user can recognize that some kinds of events have occurred in the multifunction machine 10, specifically an event that obstructs or might obstruct use of the multifunction machine 10 occurs. Specifically, the message is output not only in the visual form but also in the auditory form as the voice, and therefore, recognizability of the message by the user is improved.

Note that the dialogue box 200 is displayed across a predetermined first period Ta. The first period Ta can be set as necessary, and for example, is 30 seconds. On the other hand, the voice output from the speaker 38a is, for example, output only once to such an extent that no feeling of discomfort is provided to the user. Moreover, the dialogue box 200 is a so-called modeless (non-modal) dialogue. Thus, even while the dialogue box 200 is being displayed, other portions of the display surface (the home screen 100 in FIG. 5) of the display 24b than the dialogue box 200 can receive the user operation. When the user operation is made while the dialogue box 200 is being displayed, displaying of the dialogue box 200 ends, i.e., ends forcibly. At this point, in a case where the voice (message) is being output from the speaker 38a, the output of the voice from the speaker 38a forcibly ends. In other words, when the user operation is made during the output of the message, the output of the message forcibly ends. The user operation described herein includes not only operation of the touch panel 24a, but also operation of each of the power saving button 24c and the home button 24d.

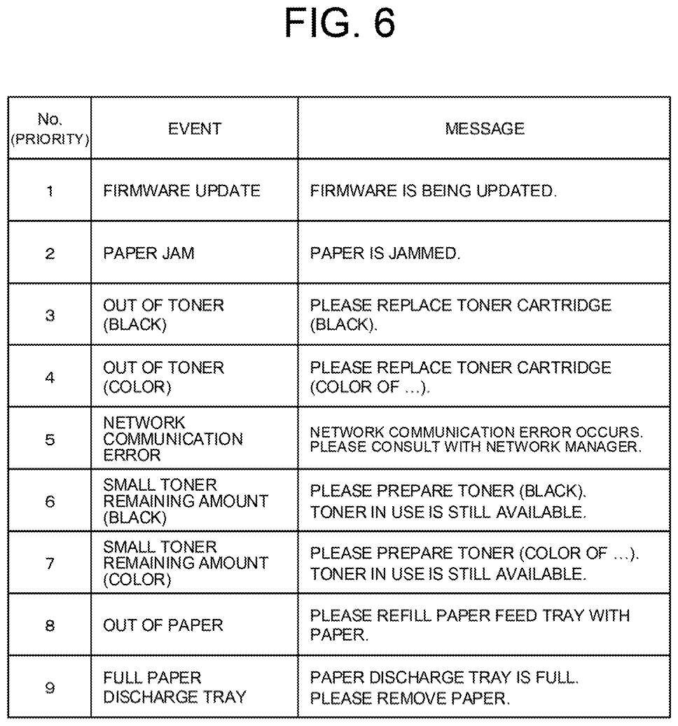

FIG. 6 illustrates a list of events that need to be notified to the user. Nine events are assumed herein. An individual event number (No.) is assigned to each event. In addition, message contents are defined for each event. That is, when any event occurs, the message corresponding to such an event is output as described above.

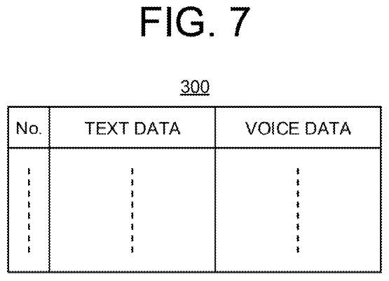

Thus, original message data corresponding to each event illustrated in FIG. 6 is stored in advance in the message table 300 as illustrated in FIG. 7. Specifically, for each event, data indicating the event number, text data as original data of the character string 202 in the dialogue box 200, and voice data as original data of the voice output from the speaker 38a are stored in the message table 300. When any event occurs, the dialogue box 200 including the character string 202 based on the text data corresponding to such an event is displayed, and the voice based on the voice data corresponding to the event is output from the speaker 38a. The message table 300 is, for example, stored in the rewritable non-volatile memory of the main storage 30b as described above.

Note that each event number is an indicator of the priority of the corresponding event. For example, the event with a smaller value of the event number indicates a higher priority. The priority is utilized upon re-notification described later.

Moreover, occurrence of each event is grasped in the following manner. For example, firmware update is grasped in such a manner that predetermined firmware updating operation as the user operation is performed. Paper jam is grasped based on a paper sensing signal from the above-described paper delivery sensor, i.e., a sensing result by the paper delivery sensor. Out of black toner or color toner and a small toner remaining amount are grasped by the image former 18. A network communication error is grasped by the communicator 34. Out of paper in the paper feeding cassette 20a is grasped based on a paper feeding sensing signal from the above-described paper feeding sensor, i.e., a sensing result by the paper feeding sensor. Moreover, the full paper discharge tray is grasped based on a paper discharge detection signal from the above-described paper discharge sensor, i.e., a sensing result by the paper discharge sensor.

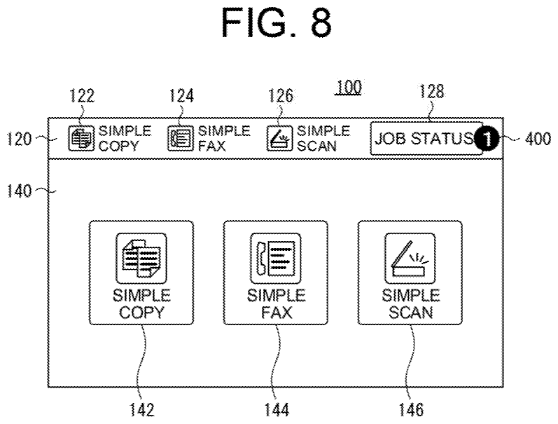

When the message corresponding to any event is output, if the user is not present at the periphery of the multifunction machine 10, such a message is not delivered to the user. In this case, as illustrated in FIG. 8, a badge 400 as an indicator is displayed at a proper position on the screen (in FIG. 8, the home screen 100) of the display 24b, such as at the side of the job status checking button 128 (specifically, to cover a right end portion of the job status checking button 128).

Specifically, only in a case where the user is continuously sensed by the human sensor 26 across a predetermined second period Tb after the start of the output of the message, it is determined that the message is delivered to the user. In other cases, it is determined that the message is not delivered to the user. When there is the message not delivered to the user, i.e., an undelivered message, the badge 400 is displayed. Note that the second period Tb is preferably equal to or shorter than the above-described first period Ta (Tb<Ta), and for example, is 10 seconds.

Further, a number indicating an undelivery number as a number of undelivered messages is assigned to the inside of the badge 400. Note that FIG. 8 illustrates a state in which the undelivery number is “1.” For example, in a case where the user is not present at the periphery of the multifunction machine 10 in the state illustrated in FIG. 5, the multifunction machine 10 transitions to the state illustrated in FIG. 8. On the other hand, in a case where the user is present at the periphery of the multifunction machine 10 in the state illustrated in FIG. 5, the multifunction machine 10 returns to the state illustrated in FIG. 4. Although not seen from FIG. 8, the badge 400 is displayed in a noticeable color for improvement of visibility of the badge 400, and for example, is displayed in red. The form of the badge 400 such as a position, a size, a shape, and a color is one example, and is not limited to the contents described herein.

In other words, when there are the undelivered messages, such a state and the undelivery number as the number of undelivered messages are displayed by the badge 400. Thus, the user can intuitively recognize, from an indication of the badge 400, the presence of the undelivered messages and the undelivery number as the number of undelivered messages. Moreover, the badge 400 is a relatively-small indicator, i.e., additional information of the screen (for example, the home screen 100 in FIG. 8) displayed on the display 24b. Thus, the badge 400 is not interference with such a screen.

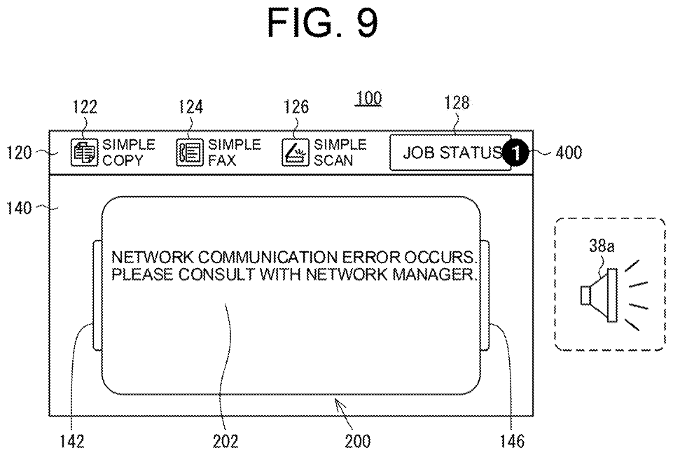

Note that when a different event that needs to be notified to the user occurs in the state illustrated in FIG. 8, the multifunction machine 10 transitions to a state illustrated in FIG. 9. That is, the dialogue box 200 including the character string 202 indicating the contents of the occurred event is displayed on the display 24b. In addition, the voice indicating the same contents as those of the character string 202 is output from the speaker 38a. At this point, the badge 400 indicating that the undelivery number is “1” is continuously displayed. Note that FIG. 9 illustrates a state in which the network communication error occurs as the different event.

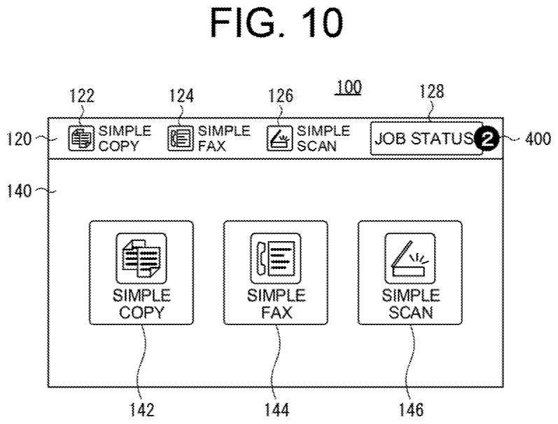

In a case where the user is not present at the periphery of the multifunction machine 10 in the state illustrated in FIG. 9, the multifunction machine 10 transitions to a state illustrated in FIG. 10. That is, the number of undelivered messages is increased by one, and the number indicating the undelivery number assigned to the badge 400 becomes “2.” On the other hand, in a case where the user is present at the periphery of the multifunction machine 10 in the state illustrated in FIG. 9, the multifunction machine 10 returns to the state illustrated in FIG. 8.

Further, the badge 400 has a function as an operator that receives operation for displaying the contents of the undelivered message. That is, although detailed description including illustration will be omitted, when the badge 400 is operated, an undelivered message list screen indicating the contents of the undelivered messages in the form of a list is displayed on the display 24b. Thus, the user can recognize the contents of the undelivered messages from an indication of the undelivered message list screen.

Moreover, although detailed description including illustration will be omitted, when predetermined operation is performed, an event list screen indicating the currently-occurred events in the form of a list is displayed on the display 24b. Thus, the user can recognize the currently-occurred events from an indication of the event list screen.

Suppose that the undelivered message is currently present and some kinds of user operation is made in this state. The undelivered message is output again, i.e., re-notification of the undelivered message is performed. At this point, in a case where there are two or more undelivered messages, re-notification of a message corresponding to a highest-priority event as an event with the highest priority among these two or more undelivered messages is performed.

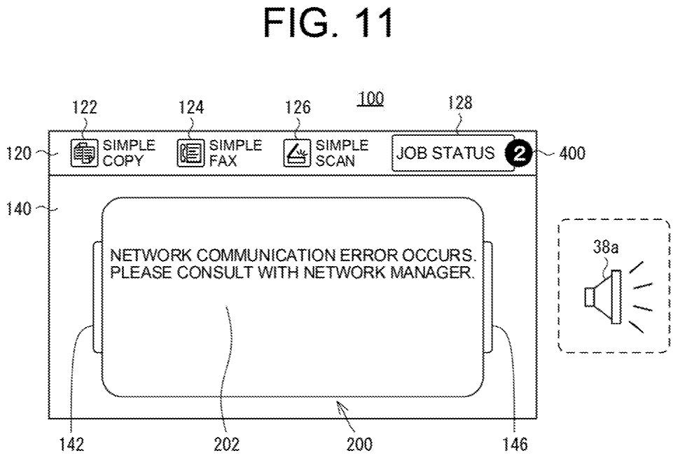

For example, when some kinds of user operation is made in the state illustrated in FIG. 10, the multifunction machine 10 transitions to a state illustrated in FIG. 11. That is, in the state illustrated in FIG. 10, there are two undelivered messages including the message corresponding to the network communication error event and the message corresponding to the small black toner remaining amount event. In this state, when some kinds of user operation is made, re-notification regarding the message corresponding to the network communication error as the highest-priority event among the two undelivered messages is performed as illustrated in FIG. 11. During such re-notification, precisely displaying of the dialogue box 200 including the character string 202, the value of the number assigned to the badge 400 is maintained at a value right before re-notification. Then, when re-notification ends, precisely when displaying of the dialogue box 200 ends, such a state is considered as completion of delivery of the message relating to re-notification to the user. Thus, the number of undelivered messages is decreased by one, and in other words, a number corresponding to a number of re-notifications is subtracted from the undelivery number. Although not illustrated in the figure, the indication of the badge 400 is updated accordingly, and the value of the number assigned to the badge 400 is decreased by one. Note that in a case where the undelivery number is decreased by one and reaches zero (0), the indication of the badge 400 is eliminated. Moreover, in a case where some kinds of user operation is made during re-notification, such re-notification forcibly ends, i.e., the output of the message forcibly ends.

Such re-notification is based on an assumption that the multifunction machine 10 is in the above-described normal mode. Thus, in a case where the multifunction machine 10 is in the above-described power saving mode, transition of the multifunction machine 10 from the power saving mode to the normal mode is a precondition for re-notification. Moreover, the user operation described herein includes not only operation of the touch panel 24a, but also operation of each of the power saving button 24c and the home button 24d. Note that in a case where the power saving button 24c is operated in a state in which there is an undelivered message, the multifunction machine 10 transitions from the normal mode to the power saving mode after re-notification regarding such an undelivered message is performed. In a case where the power saving button 24c is operated in a state in which there is two or more undelivered messages, the multifunction machine 10 transitions from the normal mode to the power saving mode after re-notification regarding a message corresponding to the highest-priority event among these two or more undelivered messages is performed.

In addition, some of the events illustrated in FIG. 6, such as the network communication error, might be solved voluntarily (on its own). In a state in which the event that might be solved voluntarily occurs and the message corresponding to such an event is taken as the undelivered message, in a case where such an event is, for example, solved voluntarily, a number corresponding to a number of such solved events is subtracted from the undelivery number. Although not illustrated in the figure, the indication of the badge 400 is updated accordingly, and the value of the number assigned to the badge 400 is decreased by one. In this case, when the undelivery number is decreased by one and reaches zero, the indication of the badge 400 is eliminated.

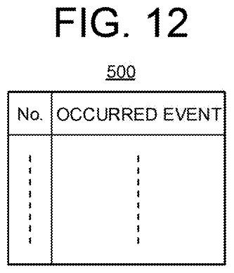

For implementing such a badge displaying function, the rewritable non-volatile memory of the above-described main storage 30b stores, for example, an event management table 500 illustrated in FIG. 12 in addition to the message table 300 illustrated in FIG. 7. The event management table 500 stores data indicating the event occurred in the multifunction machine 10, and specifically stores data indicating the event number of such an event. Moreover, a management number (No.) is, in the order of occurrence of the event, assigned to so-called occurred event data stored in the event management table 500.

In addition, the rewritable non-volatile memory of the main storage 30b stores a not-illustrated temporary storage table for directly copying the contents of the event management table 500 at certain timing. The timing of copying the contents of the event management table 500 in the temporary storage table will be described later in detail.

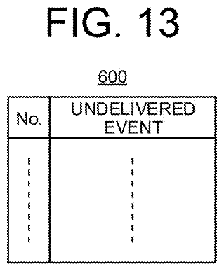

Further, the rewritable non-volatile memory of the main storage 30b stores an undelivery management table 600 illustrated in FIG. 13. The undelivery management table 600 stores data indicating the event regarding the undelivered message, and specifically stores data indicating the event number of such an event. Moreover, a management number (No.) is, in the order of taking the message as the undelivered message, assigned to so-called undelivered event data stored in the undelivery management table 600.

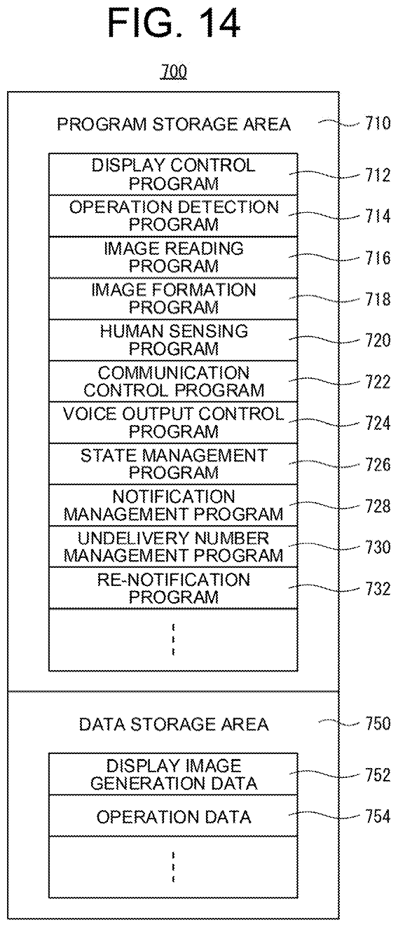

FIG. 14 illustrates a memory map 700 conceptually illustrating a configuration in the RAM of the main storage 30b.

As illustrated in the memory map 700, the RAM of the main storage 30b has a program storage area 710 and a data storage area 750. Of these areas, the program storage area 710 stores the above-described control program. The control program includes a display control program 712, an operation detection program 714, an image reading program 716, an image formation program 718, a human sensing program 720, a communication control program 722, and a voice output control program 724. Further, the control program includes a state management program 726, a notification management program 728, an undelivery number management program 730, and a re-notification program 732, for example.

The display control program 712 is a program for generating display screen data necessary for displaying various screens such as the home screen 100 and the dialogue box 200 on the display 24b. The operation detection program 714 is a program for detecting an operation state of the operation device 24, specifically the touch panel 24a. The image reading program 716 is a program for controlling the image reader 12. The image formation program 718 is a program for controlling the image former 18. The human sensing program 720 is a program for determining the presence or absence of the persons (precisely, some kinds of objects including persons) in the sensing area A based on the human sensing signal output from the human sensor 26, i.e., based on a sensing result by the human sensor 26. The communication control program 722 is a program for controlling the communicator 34. Moreover, the voice output control program 724 is a program for controlling the voice outputter 38.

Further, the state management program 726 is a program for causing the CPU 30a to execute a later-described state management task. The notification management program 728 is a program for causing the CPU 30a to execute a later-described notification management task. The undelivery number management program 730 is a program for causing the CPU 30a to execute a later-described undelivery number management task. Moreover, the re-notification program 732 is a program for causing the CPU 30a to execute a later-described re-notification task.

On the other hand, the data storage area 750 stores various types of data. These various types of data include, for example, display image generation data 752 and operation data 754.

The display image generation data 752 is data such as polygon data and texture data used for generation of the display screen data based on the above-described display control program 712. Moreover, the operation data 754 is data indicating the operation state of the touch panel 24a, and is specifically time-series data indicating a touch position (coordinates) of the touch panel 24a by the user.

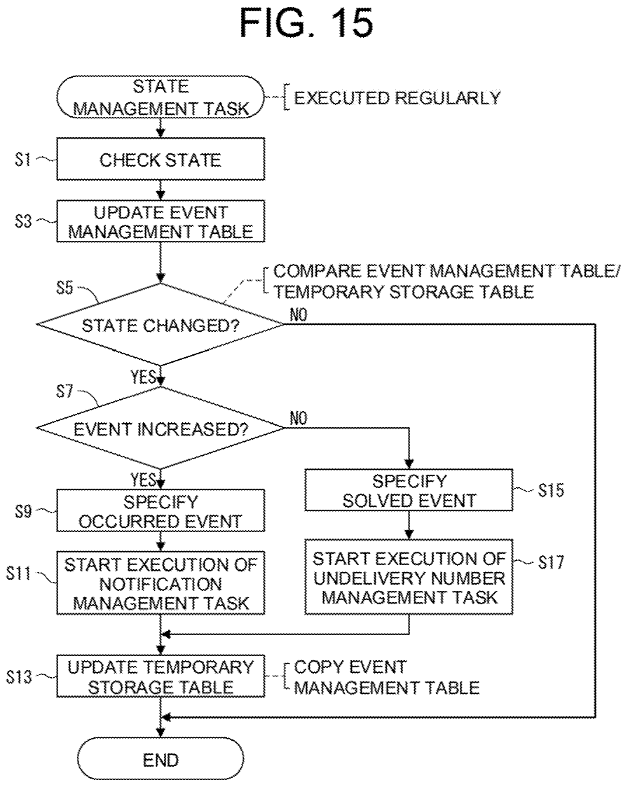

The CPU 30a executes the state management task according to the state management program 726. The flow of the state management task is illustrated in FIG. 15. Note that the state management task is executed regularly, and is repeatedly executed at a relatively-short time interval (cycle) of several seconds to several minutes. When the state management task is initially executed, such as right after the multifunction machine 10 is powered on, the above-described temporary storage table is initialized, i.e., the contents of the temporary storage table are deleted.

According to the state management task, the CPU 30a first checks the state of the multifunction machine 10 at a step S1, and specifically checks whether or not the event that needs to be notified to the user occurs. Then, the CPU 30a proceeds the processing to a step S3.

At the step S3, the CPU 30a stores a check result at the step S1 in the event management table 500, i.e., updates the event management table 500. Then, the CPU 30a proceeds the processing to a step S5.

At the step S5, the CPU 30a compares the contents of the event management table 500 and the contents of the above-described temporary storage table to determine whether or not an occurrence state of the event that needs to be notified to the user changes. For example, in a case where there is no change in the occurrence state of the event that needs to be notified to the user (S5: NO), the CPU 30a ends the state management task. On the other hand, there is a change in the occurrence state of the event that needs to be notified to the user (S5: YES), the CPU 30a proceeds the processing to a step S7.

At the step S7, the CPU 30a determines whether or not the event that needs to be notified to the user increases. For example, in a case where the event that needs to be notified to the user increases, i.e., some kinds of new events have occurred (S7: YES), the CPU 30a proceeds the processing to a step S9. On the other hand, in a case where the event that needs to be notified to the user decreases, i.e., any event is solved (S7: NO), the CPU 30a proceeds the processing to a later-described step S15.

At the step S9, the CPU 30a specifies the newly-occurred event. Then, the CPU 30a proceeds the processing to a step S11 to perform notification regarding the newly-occurred event.

At the step S11, the CPU 30a starts execution of the notification management task based on the above-described notification management program 728. Although the notification management task will be described later in detail, the notification management task is executed to perform notification regarding the newly-occurred event, i.e., output the message for such an event. In addition, the undelivery management table 600 (the undelivery number) is updated, and the indication of the badge 400 is updated. After execution of the step S11, the CPU 30a proceeds the processing to a step S13.

At the step S13, the CPU 30a updates the above-described temporary storage table, and specifically copies the contents of the event management table 500 in the temporary storage table. After execution of the step S13, the CPU 30a ends the state management task.

In a case where the CPU 30a proceeds the processing from the above-described step S7 to the step S15, the CPU 30a specifies the solved event at the step S15. Then, the CPU 30a proceeds the processing to a step S17 to subtract the number corresponding to the number of solved events from the undelivery number.

At the step S17, the CPU 30a starts execution of the undelivery management task based on the above-described undelivery number management program 730. Although the undelivery management task will be also described later in detail, execution of the undelivery management task updates the undelivery management table 600 (the undelivery number), and updates the indication of the badge 400. After execution of the step S17, the CPU 30a proceeds the processing to the above-described step S13.

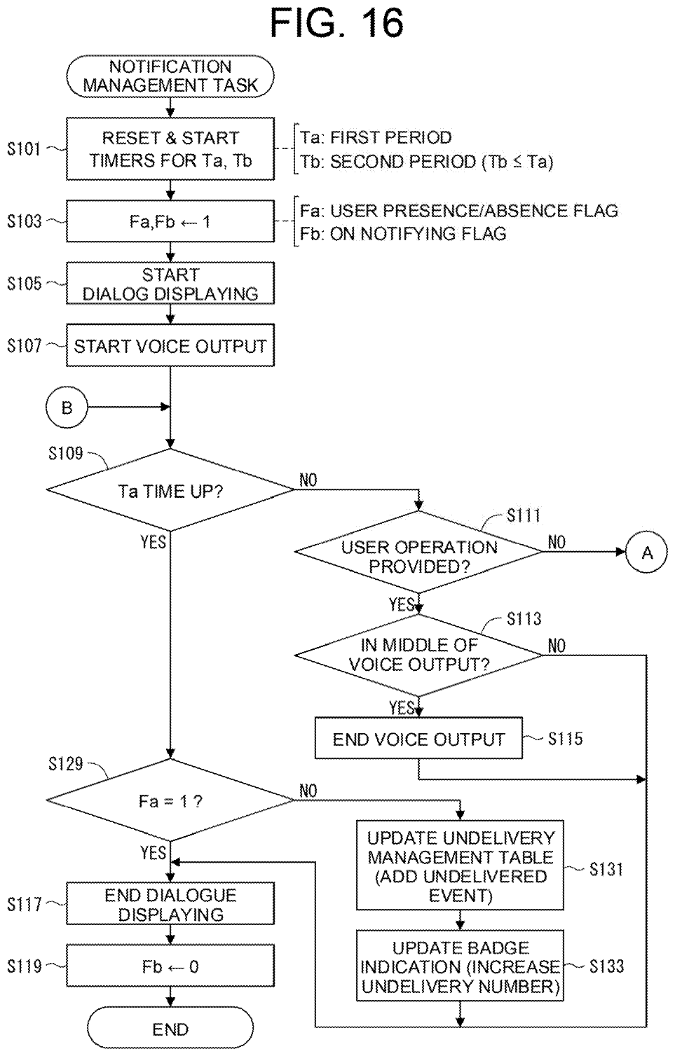

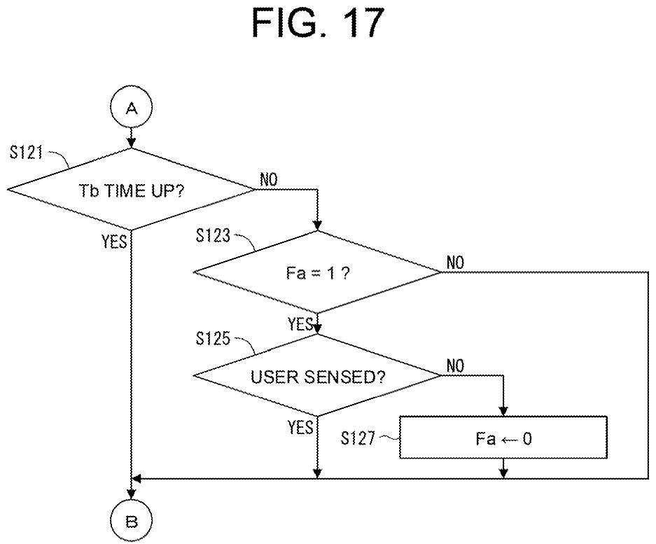

Next, the notification management task will be described. As described above, when a new event that needs to be notified to the user occurs, the CPU 30a identifies such a newly-occurred event, and thereafter, starts execution of the notification management task. The flow of the notification management task is illustrated in FIGS. 16 and 17. Moreover, the CPU 30a executes the notification management task according to the notification management program 728.

According to the notification management task, the CPU 30a first resets, at a step S101, a timer for counting the above-described first period Ta and a timer for counting the second period Tb, and thereafter, starts the timers. Note that any of these timers is a software timer implemented by the CPU 30a, but may be a hardware timer implemented by a circuit separated from the CPU 30a. Moreover, as described above, the first period Ta is the period for displaying the dialogue box 200, and for example, is 30 seconds. In addition, the second period Tb is the period utilized upon determination on whether or not the message is delivered to the user, and for example, is 10 seconds. After execution of the step S101, the CPU 30a proceeds the processing to a step S103.

At the step S103, the CPU 30a sets each of two flags Fa, Fb to “1.” The flag Fa described herein is a user presence/absence flag indicating whether or not the user is present at the periphery of the multifunction machine 10, precisely whether or not the user is continuously present at the periphery of the multifunction machine 10 until a lapse of the first period Ta after the start of counting of the first period Ta. For example, when “1” is set for the user presence/absence flag Fa, the user presence/absence flag Fa indicates that the user is present at the periphery of the multifunction machine 10. On the other hand, when “0” is set for the user presence/absence flag Fa, the user presence/absence flag Fa indicates that no user is present at the periphery of the multifunction machine 10. Moreover, the flag Fb is a notification flag indicating whether or not notification is being currently performed, i.e., the message is being output. For example, when “1” is set for the notification flag Fb, the notification flag Fb indicates that notification is being currently performed. On the other hand, when “0” is set for the notification flag Fb, the notification flag Fb indicates that notification is not being currently performed. After execution of the step S103, the CPU 30a proceeds the processing to a step S105.

At the step S105, the CPU 30a starts displaying of the dialogue box 200 including the character string 202 indicating the contents of the newly-occurred event, i.e., starts the output of the message in the visual form as the dialogue box 200. Then, the CPU 30a proceeds the processing to a step S107.

At the step S107, the CPU 30a starts the output of the voice indicating the contents of the newly-occurred event from the speaker 38a, i.e., starts the output of the message in the auditory form as the voice. Note that such voice is output only once as described above. Then, the CPU 30a proceeds the processing to a step S109.

At the step S109, the CPU 30a determines whether or not the time by the timer for counting the first period Ta is up, i.e., whether or not the first period Ta elapses after the start of counting of the first period Ta. For example, in a case the first period Ta elapses (S109: YES), the CPU 30a proceeds the processing to a later-described step S129. On the other hand, in a case where the first period Ta dose not elapsed yet (S109: NO), the CPU 30a proceeds the processing to a step S111.

At the step S111, the CPU 30a determines whether or not some kinds of user operation have been made. For example, in a case where some kinds of user operation have been made, i.e., such user operation is made until a lapse of the first period Ta (S111: YES), the CPU 30a proceeds the processing to a step S113. Note that in this case, it is assumed that the message is delivered to the user. On the other hand, in a case where no user operation is made (S111: NO), the CPU 30a proceeds the processing to a later-described step S121.

At the step S113, the CPU 30a determines whether or not the voice is being output from the speaker 38a. For example, in a case where the voice is being output from the speaker 38a (S113: YES), the CPU 30a proceeds the processing to a step S115. On the other hand, in a case where the voice is not being output from the speaker 38a, i.e., the output of the voice from the speaker 38a has already ended (S113: NO), the CPU 30a proceeds the processing to a later-described step S117.

At the step S115, the CPU 30a ends the output of the voice from the speaker 38a, i.e., forcibly ends the output. Thereafter, the CPU 30a proceeds the processing to the step S117.

At the step S117, the CPU 30a ends displaying of the dialogue box 200. Accordingly, the output of the message ends, i.e., notification ends. Then, the CPU 30a proceeds the processing to a step S119.

At the step S119, the CPU 30a sets “0” for the notification flag Fb. This expresses the end of notification. Thereafter, the CPU 30a ends the notification management task.

In a case where the processing proceeds from the above-described step S111 to the step S121, the CPU 30a determines whether or not the time by the timer for counting the second period Tb is up at the step S121, i.e., the second period Tb elapses after the start of counting of the second period Tb. For example, in a case where the second period Tb elapses (S121: YES), the CPU 30a returns the processing to the step S109 to determine again whether or not the first period Ta elapses. On the other hand, in a case where the second period Tb does not elapsed yet (S121: NO), the CPU 30a proceeds the processing to a step S123.

At the step S123, the CPU 30a determines whether or not “1” is set for the user presence/absence flag Fa. For example, in a case where “1” is set for the user presence/absence flag Fa, in other words a case where it is currently assumed that the user is present at the periphery of the multifunction machine 10 (S123: YES), the CPU 30a proceeds the processing to a step S125. On the other hand, in a case where “0” is set for the user presence/absence flag Fa, i.e., a case where the user moves away from the periphery of the multifunction machine 10 until a lapse of the second period Tb (even a short period) (S123: NO), the CPU 30a returns the processing to the step S109.

At the step S125, the CPU 30a determines whether or not the user is present at the periphery of the multifunction machine 10, specifically whether or not the user is sensed by the human sensor 26. For example, in a case where the user is sensed by the human sensor 26 (S125: YES), the CPU 30a returns the processing to the step S109. On the other hand, in a case where no user is sensed by the human sensor 26 (S125: NO), the CPU 30a proceeds the processing to a step S127.

At the step S127, the CPU 30a sets “0” for the user presence/absence flag Fa. This expresses that the user moves away from the periphery of the multifunction machine 10 until a lapse of the second period. Then, the CPU 30a returns the processing to the step S109.

Further, the CPU 30a having proceeded the processing from the step S109 to the step S129 determines, at the step S129, whether or not “1” is set for the user presence/absence flag Fa. For example, in a case where “1” is set for the user presence/absence flag Fa, i.e., the user is continuously present at the periphery of the multifunction machine 10 until a lapse of the second period Tb (S129: YES), the CPU 30a proceeds the processing to the step S117. Note that in this case, it is assumed that the message is delivered to the user. On the other hand, in a case where “0” is set for the user presence/absence flag Fa, i.e., the user moves away from the periphery of the multifunction machine 10 until a lapse of the second period Tb (S129: NO), the CPU 30a proceeds the processing to a step S131. In this case, it is assumed that no message is delivered to the user.

At the step S131, the CPU 30a identifies the newly-occurred event as an undelivered event, and as the undelivered event data, adds the event number of the undelivered event to the undelivery management table 600, i.e., updates the undelivery management table 600. Then, the CPU 30a proceeds the processing to a step S133.

At the step S133, the CPU 30a updates the indication of the badge 400 based on the undelivery management table 600 updated at the step S131. For example, in a case where the undelivery number based on the updated undelivery management table 600 is one, the CPU 30a displays the badge 400 with a number of “1.” In a case where the undelivery number based on the updated undelivery management table 600 is greater than one, the CPU 30a adds one to the value of the number assigned to the already-displayed badge 400. Then, the CPU 30a proceeds the processing to the above-described step S119.

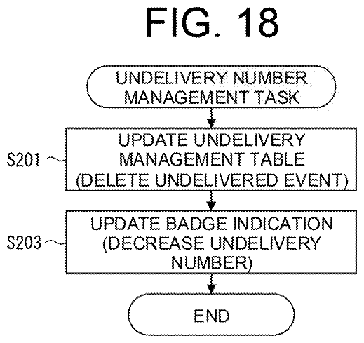

Next, the undelivery number management task will be described. As described above, when any event is solved, the CPU 30a identifies such a solved event, and thereafter, starts execution of the undelivery number management task. The flow of the undelivery number management task is illustrated in FIG. 18. Moreover, the CPU 30a executes the undelivery number management task according to the undelivery number management program 730.

According to the undelivery number management task, the CPU 30a first deletes, at a step S201, the undelivered event data corresponding to the solved event from the undelivery management table 600, i.e., updates the undelivery management table 600. Then, the CPU 30a proceeds the processing to a step S203.

At the step S203, the CPU 30a updates the indication of the badge 400 based on the undelivery management table 600 updated at the step S201. For example, in a case where the undelivery number based on the updated undelivery management table 600 is equal to or greater than one, the CPU 30a subtracts one from the value assigned to the already-displayed badge 400. In a case where the undelivery number based on the updated undelivery management table 600 is zero, the CPU 30a deletes the indication of the badge 400. Thereafter, the CPU 30a ends the undelivery number management task.

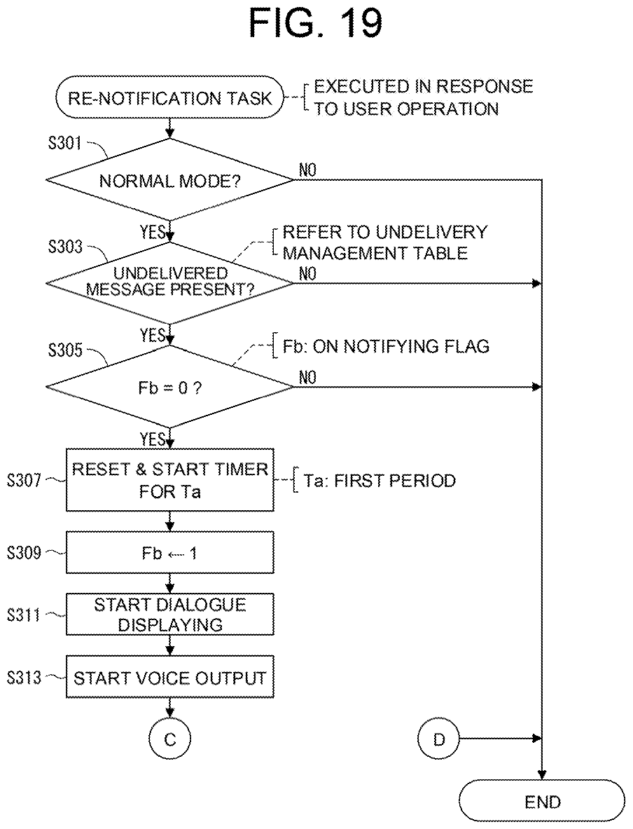

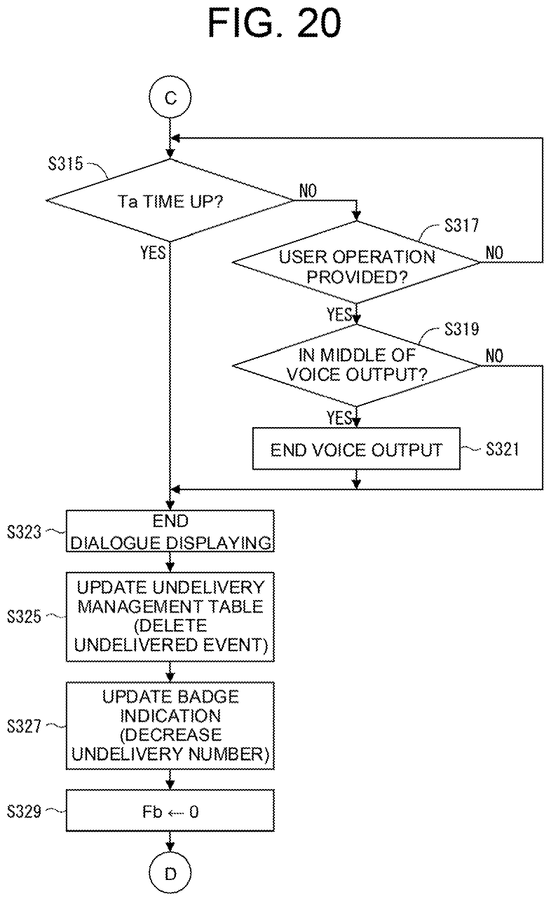

For implementing re-notification of the message as described above, the CPU 30a executes the re-notification task according to the re-notification program 732. The flow of the re-notification task is illustrated in FIGS. 19 and 20. Note that the re-notification task is executed when some kinds of user operation is made.

According to the re-notification task, the CPU 30a first determines, at a step S301, whether or not the operation mode of the multifunction machine 10 is the normal mode. For example, in a case where the operation mode of the multifunction machine 10 is not the normal mode, for example, is the power saving mode (S301: NO), the CPU 30a ends the re-notification task. On the other hand, in a case where the operation mode of the multifunction machine 10 is the normal mode (S301: YES), the CPU 30a proceeds the processing to a step S303. Note that switching of the operation mode of the multifunction machine 10 is executed by not-illustrated a different mode switching task.

At the step S303, the CPU 30a refers to the undelivery management table 600 to determine whether or not there is an undelivered message. For example, in a case where no undelivered message is present (S303: NO), the CPU 30a ends the re-notification task. On the other hand, in a case where the undelivered message is present (S303: YES), the CPU 30a proceeds the processing to a step S305.

At the step S305, the CPU 30a determines whether or not “0” is set for the notification flag Fb, i.e., whether or not the message is being output. For example, in a case where “1” is set for the notification flag Fb, i.e., a case where the message is being output (S305: NO), the CPU 30a ends the re-notification task. On the other hand, in a case where “0” is set for the notification flag Fb, i.e., a case where the message is not being output (S305: YES), the CPU 30a proceeds the processing to a step S307.

At the step S307, the CPU 30a resets the timer for counting the first period Ta, and thereafter, starts the timer. Thereafter, the CPU 30a proceeds the processing to a step S309.

At the step S309, the CPU 30a sets “1” for the notification flag Fb. This expresses that notification is being performed by re-notification. Then, the CPU 30a proceeds the processing to a step S311.

At the step S311, the CPU 30a starts displaying of the dialogue box 200 including the character string 202 indicating the contents of the highest-priority event with the highest priority among undelivered messages, i.e., starts the output of the message corresponding to the highest-priority event in the visual form. In other words, re-notification in the visual form is performed. Then, the CPU 30a proceeds the processing to a step S313.

At the step S313, the CPU 30a starts the output of the voice indicating the contents of the highest-priority event from the speaker 38a, i.e., starts the output of the message corresponding to the highest-priority event in the auditory form. In other words, re-notification in the auditory form is performed. Note that the voice as the auditory form is output only once as described above. Then, the CPU 30a proceeds the processing to a step S315.

At the step S315, the CPU 30a determines whether or not the time by the timer for counting the first period Ta is up, i.e., the first period Ta elapses after the start of counting of the first period Ta. For example, in a case where the first period Ta elapses (S315: YES), the CPU 30a proceeds the processing to a later-described step S323. On the other hand, in a case where the first period Ta does not elapse yet (S315: NO), the CPU 30a proceeds the processing to a step S317.

At the step S317, the CPU 30a determines whether or not some kinds of user operation have been made. For example, in a case where some kinds of user operation have been made, i.e., such user operation is made until a lapse of the first period Ta (S317: YES), the CPU 30a proceeds the processing to a step S319. On the other hand, in a case where no user operation is made (S317: NO), the CPU 30a returns the processing to the step S315 to determine again whether or not the first period Ta elapses.

At the step S319, the CPU 30a determines whether or not the voice is being output from the speaker 38a. For example, in a case where the voice is being output from the speaker 38a (S319: YES), the CPU 30a proceeds the processing to a step S321. On the other hand, in a case where the voice is not being output from the speaker 38a, i.e., the output of the voice from the speaker 38a has already ended (S319: NO), the CPU 30a proceeds the processing to the later-described step S323.

At the step S321, the CPU 30a ends the output of the voice from the speaker 38a, i.e., forcibly ends the output. Thereafter, the CPU 30a proceeds the processing to the step S323.

At the step S323, the CPU 30a ends displaying of the dialogue box 200. Thus, the output of the message ends, i.e., re-notification ends. Then, the CPU 30a proceeds the processing to a step S325.

At the step S325, the CPU 30a deletes the undelivered event data corresponding to the re-notified event from the undelivery management table 600, i.e., updates the undelivery management table 600. Then, the CPU 30a proceeds the processing to a step S327.

At the step S327, the CPU 30a updates the indication of the badge 400 based on the undelivery management table 600 updated at the step S325. For example, in a case where the undelivery number based on the updated undelivery management table 600 is equal to or greater than one, the CPU 30a subtracts one from the value assigned to the already-displayed badge 400. In a case where the undelivery number based on the updated undelivery management table 600 is zero, the CPU 30a deletes the indication of the badge 400. Then, the CPU 30a proceeds the processing to a step S329.

At the step S329, the CPU 30a sets “0” for the notification flag Fb. This expresses that notification by re-notification ends. Thereafter, the CPU 30a ends the re-notification task.

As described above, according to the first embodiment, when the event that needs to be notified to the user occurs, the message indicating such occurrence is output, and such a message is specifically output via the voice. While the message is being output, the presence or absence of the user at the periphery of the multifunction machine 10 is sensed by the human sensor 26. Further, based on the sensing result by the human sensor 26, it is determined whether or not the message is delivered to the user. Then, based on such a determination result, the undelivery number as the number of undelivered messages is managed. Thus, in a case where it is, for example, determined that the message is delivered to the user without the user operation, such a message is not taken as the undelivered message. Thus, accurate management of the undelivery number is implemented. Moreover, the accurately-managed undelivery number is displayed by the badge 400.

Moreover, even in a case where some kinds of user operation have been made during the output of the message, it is determined that such a message is delivered to the user. Thus, more accurate management of the undelivery number is implemented.

In addition, when there is an undelivered message and some kinds of user operation is made in this state, such an undelivered message is output again, i.e., re-notification regarding the undelivered message is performed. This is extremely useful in efficiently and reliably delivering the undelivered message to the user.

Further, in a case where there are two or more undelivered messages, re-notification regarding the message corresponding to the highest-priority event as the event with the highest priority among these two or more undelivered messages is performed. In other words, re-notification regarding the event with a high degree of importance is performed preferentially. This is also extremely useful in efficiently and reliably delivering the undelivered message to the user.

Note that in the first embodiment, the CPU 30a executing the step S107 (see FIG. 16) in the notification management task cooperates, for example, with the voice outputter 38 including the speaker 38a, thereby forming one example of a notification device according to the present invention.

Moreover, the CPU 30a determines the presence or absence of the user in the sensing area A based on the sensing result by the human sensor 26 as described above, and in other words, estimates action of the user. The CPU 30a, specifically the CPU 30a executing the step S125 (see FIG. 17) in the notification management task, cooperates with the human sensor 26 to form one example of an estimation device according to the present invention.

Further, the CPU 30a determines, based on the sensing result by the human sensor 26, whether or not the message is delivered to the user. The CPU 30a, specifically the CPU 30a executing the step S129 (see FIG. 16) in the notification management task, forms one example of a determination device according to the present invention.

In addition, the CPU 30a manages the undelivered message by means of the undelivery management table 600, and in other words, manages the undelivery number. The CPU 30a, specifically the CPU 30a executing the step S131 (see FIG. 16) in the notification management task, forms one example of a management device according to the present invention.

Moreover, the CPU 30a displays the undelivery number by the badge 400. The CPU 30a, specifically the CPU 30a executing the step S133 (see FIG. 16) in the notification management task, forms one example of a display control device according to the present invention.

When a predetermined condition where some kinds of user operation are made in a state in which there is an undelivered message is satisfied, the CPU 30a performs re-notification regarding such an undelivered message. The CPU 30a, specifically the CPU 30a executing the step S313 (see FIG. 19) in the re-notification task, cooperates with the voice outputter 38 to form one example of a re-notification device. Note that the predetermined condition described herein is not limited to the condition where some kinds of user operation are made, and for example, other conditions where the user (precisely, some kinds of objects including the user) is sensed by the human sensor 26 across a certain period may be employed.

### Second Embodiment

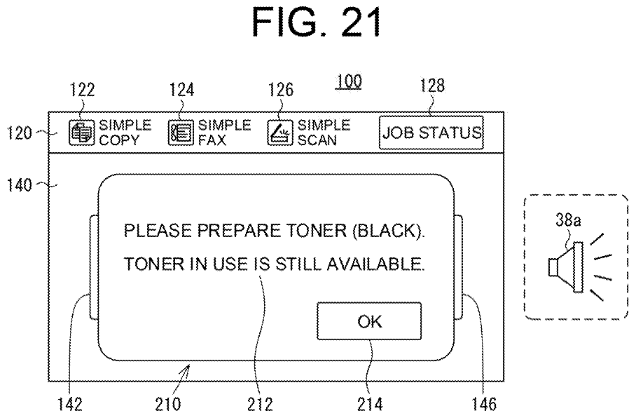

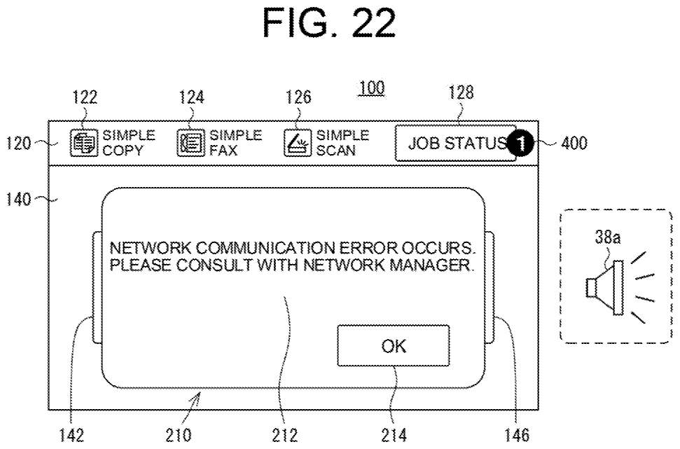

Next, a second embodiment of the present invention will be described with reference to FIGS. 21 and 22.

In the second embodiment, for example, a dialogue box 210 as illustrated in FIG. 21 is displayed instead of the dialogue box 200 in the first embodiment. The dialogue box 210 is a so-called modal dialogue, and includes a character string 212 similar to the character string 202 in the first embodiment and also includes an operator as an OK button 214.

That is, while the dialogue box 210 is being displayed, other portions of a display surface (a home screen 100 in FIG. 21) of a display 24b than the OK button 214 of the dialogue box 210 do not accept user operation. When the OK button 214 is operated while the dialogue box 210 is being displayed, displaying of the dialogue box 210 forcibly ends. At this point, in a case where voice (a message) is being output from a speaker 38a, the output of the voice from the speaker 38a also forcibly ends. In other words, the OK button 214 is operated during the output of the message, and in this manner, the output of the message forcibly ends. This is not limited to operation of the OK button 214, and the same also applies to the case of operating a power saving button 24c or a home button 24d.

Note that other configurations in the second embodiment are similar to those of the first embodiment, and therefore, detailed description of these similar configurations will be omitted. Note that at the step S111 (see FIG. 16) in the notification management task, it is determined whether or not any of the OK button 214 of the dialogue box 210, the power saving button 24c, and the home button 24d is operated. The same also applies to the step S317 (see FIG. 20) in the re-notification task.

Note that the state illustrated in FIG. 21 corresponds to the state illustrated in FIG. 5 according to the first embodiment. Moreover, one example of the state displaying the dialogue box 210 when there is an undelivered message is illustrated in FIG. 22. The state illustrated in FIG. 22 corresponds to the state illustrated in FIG. 9 according to the first embodiment.

According to the second embodiment having the above-described configuration, accurate management of an undelivery number can be implemented as in the first embodiment. Moreover, according to the second embodiment, the undelivered message can be efficiently and reliably delivered to a user.

### Third Embodiment

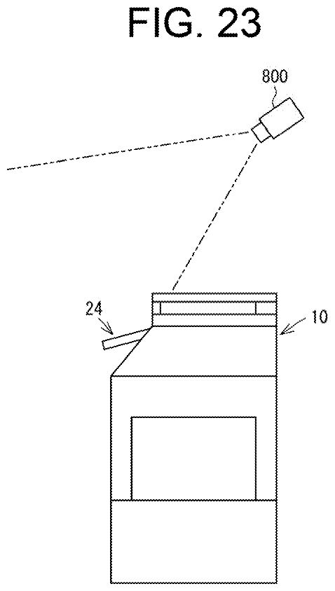

Next, a third embodiment of the present invention will be described with reference to FIG. 23.

In the third embodiment, a camera 800 as an image capturing device is provided as illustrated in FIG. 23 in addition to the configurations of the first or second embodiment. The camera 800 is, for example, provided at a proper position above a multifunction machine 10 so that an image of the periphery of the multifunction machine 10 including an operation device 24 specifically in a sensing area A of a human sensor 26 can be shot. Moreover, in the third embodiment, determination on whether or not a message is delivered to a user is made based on the image, preferably video, shot by the camera 800 in addition to a sensing result by the human sensor 26.

Specifically, based on the image shot by the camera 800, for example, motion of the eye level and head of the user and the position of the user in the sensing area A are analyzed. Then, based on such an analysis result and the sensing result by the human sensor 26, determination on whether or not the message is delivered to the user is made in a comprehensive way. Thus, the accuracy of such determination is dramatically improved, and therefore, more accurate management of an undelivery number is implemented.

Note that other configurations in the third embodiment are similar to those of the first or second embodiment, and therefore, detailed description of these similar configurations will be omitted. Note that at the step S125 (see FIG. 17) in the notification management task, the presence or absence of the user is determined based on the image shot by the camera 800 in addition to the sensing result by the human sensor 26. Preferably, instead of a proper step including the step S125, determination on whether or not the message is delivered to the user may be made in a comprehensive way based on the sensing result by the human sensor 26 and the image shot by the camera 800. In a case where it is determined that no message is delivered to the user, update of the undelivery management table 600 at the step S131 (see FIG. 16) and update of the indication of the badge 400 at the step S133 (see FIG. 16) may be executed.

According to the third embodiment having the above-described configuration, more accurate management of the undelivery number can be implemented as described above. Moreover, according to the third embodiment, the undelivered message can be more reliably and efficiently delivered to the user.

Note that in the third embodiment, determination on whether or not the message is delivered to the user is made based on the sensing result by the human sensor 26 and the image shot by the camera 800, but is not limited to above. For example, such determination may be made based only on the image shot by the camera 800.

### Other Applications

Each of the above-described embodiments is a specific example of the present invention, and is not intended to limit the technical scope of the present invention. The present invention is applicable to other aspects than each of these embodiments.

For example, the badge 400 is arranged at the side of the job status checking button 128, but may be arranged at other positions than above. Moreover, the undelivery number may be displayed by other indicators or simple character strings than the badge 400.

Moreover, the dialogue box 200 (or 210) may be in forms different from each other between initial notification and re-notification. For example, a proper mark, character, pattern, or color indicating re-notification may be assigned to the dialogue box 200 upon re-notification.

Further, upon re-notification, the indication of the badge 400 is updated after the end of displaying of the dialogue box 200, but the present invention is not limited to above. For example, the indication of the badge 400 may be updated before the start of displaying of the dialogue box 200 or at proper timing during displaying of the dialogue box 200.

In addition, in a case where the multifunction machine 10 includes a log-in function, determination on whether or not user operation for log-in is made may be made at the step S111 (see FIG. 16) in the notification management task. In this case, when the user operation for log-in is made in the middle of notification as the output of the message, it is assumed that the message is delivered to the user. Thus, determination on whether or not the message is delivered to the user having a log-in authority, i.e., the user to which the message needs to be delivered in the first place, is reliably made. Moreover, individual authentication operation such as face authentication, fingerprint authentication, or card authentication may be employed as the user operation for log-in.

Moreover, in a case where the multifunction machine 10 includes the log-in function, re-notification may be performed under a condition where the user operation for log-in is performed, i.e., the re-notification task (see FIGS. 19 and 20) may be executed. In this case, the message can be, by re-notification, reliably delivered to the user having the log-in authority, i.e., the user to which the message needs to be delivered in the first place.

Further, the list of the events as illustrated in FIG. 6 is merely one example, and the present invention is not limited to above. For example, failure to such an extent that no interference is caused in the output of the voice from the speaker 38a may be included in the events described herein.

In addition, the pyroelectric sensor as one type of the infrared sensor is employed as the human-presence sensor 26a of the human sensor 26, but the present invention is not limited to above. For example, other infrared sensors than the pyroelectric sensor or other sensors than the infrared sensor, such as an ultrasonic sensor or a visible light sensor, may be employed. Further, instead of or in addition to the human sensor 26 including the human-presence sensor 26a, other human sensing devices such as a mat-type sensor (a mat switch) may be employed.

Moreover, the electrophotographic image former 18 is employed as the image forming device, but an inkjet image former may be employed, for example. In this case, out of ink is, instead of out of the toner, included as one event that needs to be notified to the user. Moreover, instead of the event as the small toner remaining amount, a decrease in an ink remaining amount, i.e., an event as a small ink remaining amount, is included.

In addition, the example where the present invention is applied to the multifunction machine 10 is described in each embodiment, but the present invention is not limited to above. Needless to say, the present invention is also applicable to other electronic apparatuses than the multifunction machine 10.

What is claimed is:

1. An electronic apparatus including a notification device that when an event that needs to be notified to a user occurs, outputs a message corresponding to the event via voice, the electronic apparatus comprising:
an estimation device that estimates action of the user including presence or absence of the user in a predetermined area at a periphery of the electronic apparatus;
a determination device that determines, based on an estimation result by the estimation device, whether or not the message is delivered to the user; and
a management device that manages, based on a determination result by the determination device, an undelivery number as a number of messages not delivered to the user.

2. The electronic apparatus according to claim 1, further comprising:
a display device having a display surface; and
a display control device that displays a management result by the management device on the display surface.

3. The electronic apparatus according to claim 2, wherein
the display control device displays a predetermined screen on the display surface, and displays the management result as additional information on the screen.

4. The electronic apparatus according to claim 1, further comprising:
an operation receiving device that receives operation by the user,
wherein the determination device performs determination based on the estimation result and an operation result by the operation receiving device.

5. The electronic apparatus according to claim 1, wherein
when any event according to the undelivery number is solved, the management device subtracts a number corresponding to a number of solved events from the undelivery number.

6. The electronic apparatus according to claim 1, further comprising:
a re-notification device that outputs the message corresponding to each event according to the undelivery number via voice when a predetermined condition is satisfied.

7. The electronic apparatus according to claim 6, wherein
when re-notification as output of the message by the re-notification device is performed, the management device substrates a number corresponding to a number of times of execution of the re-notification from the undelivery number.

8. The electronic apparatus according to claim 6, wherein
a priority is set in advance for each event, and
in a case where the undelivery number is two or more, the re-notification device outputs, every time the predetermined condition is satisfied, the message corresponding to a highest-priority event with the highest priority among the two or more events according to the undelivery number.

9. The electronic apparatus according to claim 1, wherein
the estimation device includes at least one of a human sensing device that senses presence or absence of persons including the user in the predetermined area and an image capturing device that captures an image in the predetermined area.

10. The electronic apparatus according to claim 1, wherein
the electronic apparatus is a multifunction machine.

11. A non-transitory computer-readable recording medium storing a state management program in an electronic apparatus, the state management program causing a computer of the electronic apparatus to implement:
a notification procedure to output, when an event that needs to be notified to a user occurs, a message corresponding to the event via voice,
an estimation procedure of estimating action of the user including presence or absence of the user in a predetermined area at a periphery of the electronic apparatus,
a determination procedure of determining, based on an estimation result by the estimation procedure, whether or not the message is delivered to the user, and
a management procedure of managing, based on a determination result by the determination procedure, an undelivery number as a number of messages not delivered to the user.

12. A state management method in an electronic apparatus, the state management method comprising:
notifying to output, when an event that needs to be notified to a user occurs, a message corresponding to the event via voice;
estimating action of the user including presence or absence of the user in a predetermined area at a periphery of the electronic apparatus;
determining, based on an estimation result by the estimating, whether or not the message is delivered to the user; and
managing, based on a determination result by the determining, an undelivery number as a number of messages not delivered to the user.
